(19) United States
(12) Patent Application Publication
(10) Pub. No.: US 2005/0065906 A1
(43) Pub. Date: Mar. 24, 2005

(54) Method and apparatus for providing feedback for email filtering

(75) Inventor: Timothy L. Romero, Tokyo (JP)

Correspondence Address: MORRISON & FOERSTER LLP, 1650 TYSONS BOULEVARD, SUITE 300, MCLEAN, VA, 22102, US

(73) Assignee: WIZAZ K.K., TOKYO (JP)

(21) Appl. No.: 10/915,690

(22) Filed: Aug. 11, 2004

Related U.S. Application Data
(60) Provisional application No. 60/496,931, filed on Aug. 19, 2003.

(51) Int. Cl. G06F 7/00

(52) U.S. Cl. 707/1

(57) ABSTRACT

The invention provides a novel system for email users to provide feedback to email routing, filtering and classification systems. The invention uses email generated by standard email client software as the transport mechanism for providing this feedback, and thereby eliminates the need for custom, client-side software to be installed on the user's computer.

### RELATED APPLICATION

This Application claims the priority of previously filed U.S. Provisional Patent Application No. 60/496,931 filed on Aug. 19, 2003, which is hereby incorporated by reference in its entirety.

### FIELD OF THE INVENTION

The present invention relates to a system and method that enables users to train and provide feedback to email routing, classification, or filtering software, which will be collectively referred to as email classifiers, by using standard email client software to forward received email back to the email classifier. In this way, email classifiers that require such training can be used without the need for any dedicated software to be installed on the email recipient's computer.

### BACKGROUND OF THE INVENTION

With the widespread adoption of the Internet, email has become an essential business communications tool. Many firms have achieved significant cost reductions through extensive use of email in areas such as fielding initial customer inquiries and providing after-sales product support.

Companies usually use a small number of general-purpose email mailboxes to enable this kind of customer contact. For example, many firms maintain a “sales@company.com” address for general sales inquiries, a “support@company.com” address for support inquires, and an “info@company.com” address for other forms of inquiry.

Email received at these general-purpose mailboxes must somehow be routed to the correct person within the organization. Since a great deal of email is received at these addresses, the cost of dedicating a trained individual to examine each incoming email and send it to the appropriate person often offsets the initial cost savings of using email. Furthermore, the vast majority of the emails received at these addresses are often not legitimate customer inquiries, but unsolicited advertising email or “spam”, further increasing the cost.

To address this problem, institutions often employ automated email filters, routers, and similar devices and systems referred to herein as email classifiers. The technologies that underlie email classifiers are varied. The most common are rule-based systems that analyze specific attributes of the email such as: the sender, the recipients, the IP address from which the email was sent, the presence or absence of keywords or information in the text or header.

Recently, rule-based systems have been augmented or replaced by systems that employ statistical analysis of the email to build a statistical profile of each category into which the emails are sorted. One example of which is Bayesian analysis. While effective, these statistical-based email classifiers require sample email and feedback from email recipients in order to build and refine the statistical profiles.

Currently there are two approaches to enabling the user to provide this requisite feedback; the dedicated interface technique and the integrated technique. Both methods are commonly used.

Examples of dedicated interface techniques are described in U.S. Pat. No. 6,592,627 by Agrawal et al., U.S. Pat. No. 6,421,709 by McCormick et al., and in U.S. Patent Application 2004/0039786 by Horvitz et al. These systems all use a custom-designed user interface to enable the user to provide the requisite feedback to the email classifier.

The dedicated interface approach is flexible and widespread, but suffers from a number of deficiencies.

First, although some form of email client software is available for virtually all personal computer operating systems, it is impractical to develop a dedicated interface for each of these operating systems due to the costs involved in developing, testing, and supporting the dedicated interface. Thus, in practice, the applicability of the dedicated interface approach is restricted to only the most widespread computer platforms.

Second, the dedicated interface restricts the user's ability to provide feedback to the email classifier. To interact with the mail server and update the profiles, the dedicated interface must be able to make a connection to the email classifier. As long as the user machine is running and the dedicated interface remains on the same local area network (LAN) as the email classifier, this is not a problem. However, in actual use, email is often checked from computers that do not have the dedicated interface installed, such as a computer at home or at a hotel business center, laptops, or other remote locations that are disconnected from the LAN.

Third, the dedicated interface software must be installed and supported on all client machines and users must be trained in its use. Depending on the size of the organization and the technological sophistication of its members or employees, deploying a dedicated interface can potentially be a very expensive undertaking. Any time software is installed or updated, there is a chance that it will conflict with other software already installed on the computer and thereby render itself and/or the program it has conflicted with un-operable and/or unstable. The risk of such software conflicts increases geometrically with each software program installed.

The integrated technique is described in relation to various analysis and filtering techniques in U.S. Pat. No. 6,161,130 by Horvitz et al. and in U.S. Patent Application 2004/40083270 by Heckerman et al.

In the integrated technique, the user's email client application monitors specific user actions such as deleting an email, moving an email to a certain folder, or forwarding email to a specific individual. Based on these actions, the integrated software deduces the nature of the email in question and determines whether or not it should be used as feedback to the email classifier.

Since there is no dedicated training interface, the feedback activities are largely invisible to the user. Thus, the integrated technique is superior to the dedicated interface technique in the sense that it potentially does not require the end-users to be trained in how to use the system. However, it is uncertain how accurately such software is able to determine the user's intentions from such actions.

Not only does the integrated technique suffer from the limitations described above, but the tight integration required between the email client and the email classifier renders the first two limitations described above in reference to a dedicated interface potentially even more severe when using the integrated technique.

It is therefore desirable to have a technique to provide an email classifier with user feedback, and does not require the development and installation of special software on the user's computer, can be used on all computer operating systems that support email, and operates even when the user's computer is not connected to the email classifier.

### SUMMARY OF THE INVENTION

In one embodiment of the present invention, the end users can provide feedback to an email classifier using their present email client software without having to modify their client software or install additional software. In a preferred embodiment, the email itself is used as the message transport mechanism by which the user communicates with, and provides training to, the email classifier.

As the email classifier processes email according to an embodiment of the present invention, it can store a copy of the incoming email, and/or a copy of the statistics derived from the email, to an email database. The email classifier may then construct an index to this information based on the information contained in the email's header.

When the user wishes to train the email classifier as to how a particular email message should be classified, the user can forward that email to a control mailbox. The original email received by the user is referred to hereinafter as the “example email,” while the forwarded email sent to the control mailbox is referred to hereinafter as the “training email.”

According to an embodiment, the example email can be contained in the body of the training email if only one example email is being provided. According to another embodiment, the email is preferably attached to the training email when multiple example emails are provided.

Depending on the embodiment, the control mailboxes may be referred to as dedicated mailboxes or general mailboxes. A dedicated control mailbox corresponds to a specific training command. According to an embodiment, the email address “spam_feedback@company.com” may be used as a mailbox to which training emails containing examples of spam emails are sent. The email classifier may then use the example emails to update its filters.

According to an embodiment, a general control mailbox may utilize commands that are contained in the training email to determine how, and if, the example emails are to be processed. The commands are preferably located in either the subject or the body of a training email. The general control mailboxes are flexible in that they allow training email to be sent to the same address as non-training email. According to an embodiment, training email intended to update different filters may also be sent to the same address.

According to an embodiment of the present invention, when email is received at a general control mailbox the sender's authorization to provide training may be verified by checking the email address in the “From” header of the training email against a list of approved email addresses. In an alternate embodiment, a password contained in the body of the training email may be verified.

If the authorization fails, training may not take place. If the authorization succeeds, the example email or emails may then be extracted from the training email and may be processed as described above.

If the example email has been included in the body of the training email as a forwarded message, then the header information of the example email may be extracted. This information may vary among different email clients, but usually includes the original email recipient, the original email sender, the original email subject, and the date and time the original email was sent. The extracted information may then be used to look up the original message or its derived statistics in the email database.

According to another embodiment, if the example emails have been included as attachments to the training email, then each of the attached emails may be extracted and processed. Example emails provided as attachments to the training emails may contain more complete information than do example emails copied into the body of a training email. This is because email clients generally remove most of the email header information from the example email before copying the contents into the training email. However, when an email client creates a training email by forwarding the example email as an attachment, the header information is generally preserved.

Looking up the original information from the email database is optional when the example emails are sent as attachments because all of the original information is generally present. According to an embodiment, the email classifier may analyze the attached example messages. According to another embodiment, the email classifier may look up the information in the email database to improve the performance and security of the implemented system.

Additional features and advantages of the present invention will be more readily apparent from the following detailed description, which refers to the accompanying Figures.

### DESCRIPTION OF THE FIGURES

FIG. 1 shows an example of a diagram of a routing email classifier according to an embodiment of the present invention.

FIG. 2 shows an example of a typical email with header according to an embodiment of the present invention.

FIG. 3 shows an example of a sample index entry from email database according to an embodiment of the present invention.

FIG. 4 shows an example of a diagram of a proxy email classifier according to an embodiment of the present invention.

FIG. 5 shows an example of a diagram of use of dedicated control mailbox according to an embodiment of the present invention.

FIG. 6 shows an example of training email according to an embodiment of the present invention.

FIG. 7 shows an example of the flow of data extraction from a header block according to an embodiment of the present invention.

FIG. 8 shows an example of a search index generated from training email according to an embodiment of the present invention.

FIG. 9 shows an example of the flow of the index matching according to an embodiment of the present invention.

FIG. 10 shows an example of a diagram of use of general control mailbox according to an embodiment of the present invention.

### DETAILED DESCRIPTION OF THE PREFERRED EMBODIMENT

To illustrate the principles of the invention, the following discussion details several exemplary embodiments in conjunction with common email classifier configurations. However, the invention is not so limited, and can be applied to email classifiers having other configurations.

Email classifiers can use an arbitrarily large number of categories. To simplify the discussion, the diagrams and examples used herein will use an embodiment having only two categories; “spam” and “not spam.” It will be readily apparent to those skilled in the art that the embodiments of the present invention may use an unlimited number of categories.

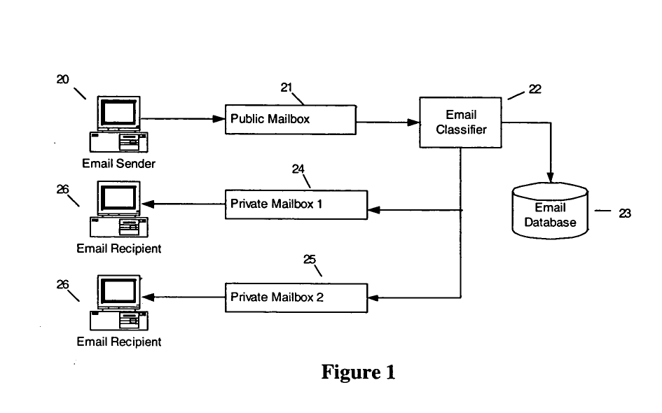

FIG. 1 shows an example of a typical routing email classifier in accordance with one preferred embodiment. In this example, email may be sent by the Email Sender (20) to a known email address corresponding to Public Mailbox (21). The email classifier (22) may then read the email from the public mailbox (21), analyze it using techniques specific to that classifier, and classify it as “spam” or “not spam.” The email classifier (22) may then save a copy of the original email in the Email Database (23) and create an index as described in the next section. The copy may include all of the header information. The Email Database (23) may be any form of persistent storage. Examples of various embodiments have Email Databases (23) comprising plain text files, encrypted text files, or various other commercially available relational database systems. An alternative embodiment may store the statistics derived from the analysis instead of the complete email.

Depending on the result of the classification and the configuration of the system, the email classifier (22) may then send the email to zero or more private mailboxes (24, 25). In an embodiment in which the email classifier is integrated with the email server, the email can be placed directly into the private mailboxes. In an embodiment in which the email classifier is not integrated with the email server, the email classifier may re-send the email using an email transport protocol. SMTP is an example of an email transport protocol.

Users may then use standard email client software to check the mailboxes. In an embodiment, email classified as spam may be sent to Private Mailbox 1 (24) from where it may later be retrieved by an Email Recipient (26). Non-spam email may be sent to Private Mailbox 2 (25) where it may later be retrieved by either the same or a different Email Recipient (26).

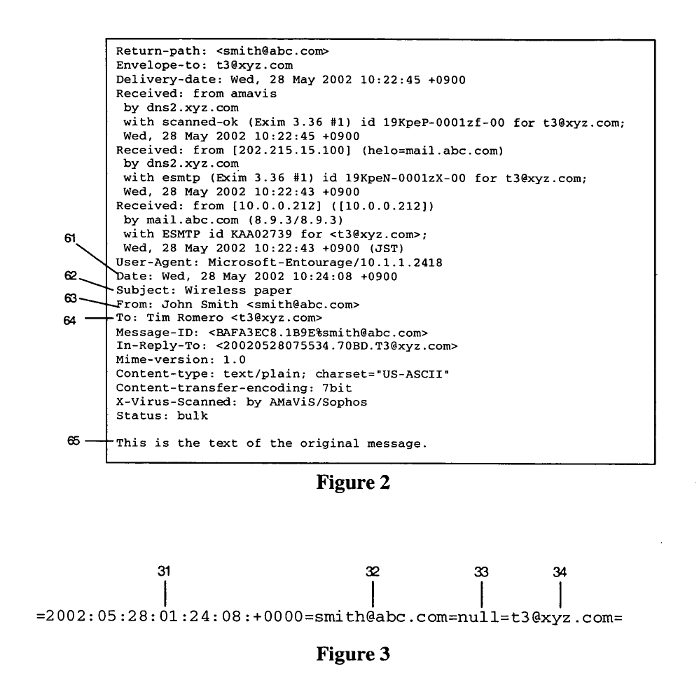

Indexing the email database is optional according to an embodiment, if the full-text of the email is stored. However, if the derived statistics are stored, indexing the email database is preferred. Indexing may generally improve the performance of the system. FIG. 2 shows an example of a typical email message with header information according to an embodiment. In an embodiment of the present invention, the following information may be extracted from an email header to create an index of the email database: the Date header (61), the From header (63), the To header (64), and the Sender header if present. The Sender header is frequently is not present in emails, and therefore, it is not shown in FIG. 2. The format of the Sender header may be similar to the other email headers if present.

In an alternative embodiment, the Subject header (62) and the body (65) of the message may also be extracted and used in the index.

FIG. 3 shows an example index entry of the email of FIG. 2 in a form suitable for a delimited text-based database according to another embodiment. Those skilled in the art will recognize that the index is not restricted to the embodiment shown in FIG. 3, but can take many forms depending on the nature of the email database.

The index entry shown in FIG. 3 uses an equals sign “=” as a delimiter. In this example, the values of the Date field (31) are converted to a common format, shown here by way of example as normalized to GMT, to facilitate faster lookups. The From field (32) may be stripped of descriptive information, such as the individual's name. The basic email address may then be stored. The email shown in FIG. 2 does not contain a Sender header. Therefore, the placeholder phrase “null” is stored as the Sender field (33). When the Sender header is present, it may be reduced to its basic email address and stored similar to the From field as described above. The To address (34) may also be reduced to its basic email address in the manner described above.

The order and format in which this information is stored is not critical, and additional information such as the subject or even the complete body of the email may be included as well. However, reducing the email addresses is essential to the present embodiment. The reduction is essential to this embodiment because the way in which email clients format forwarded email varies considerably. While it is essential to reduce the email in this embodiment, the way in which the email is reduced, and the form the email is reduced to, is not limited to the embodiments shown herein as examples. Another embodiment may also store the Sender field to compensate for the variety of formats, as explained below. In an embodiment explained below, the email classifier may be trained without reducing the email.

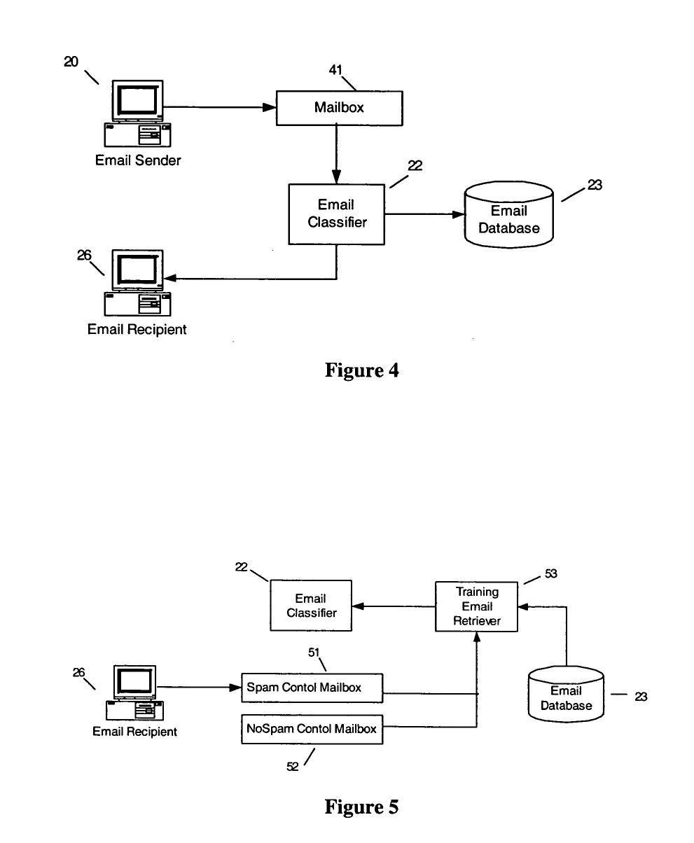

FIG. 4 shows an example of a typical proxy email classifier used in conjunction with an embodiment of the present invention. In this embodiment, the Email Sender (20) sends email to a known email Mailbox (41). When the Email Recipient (26) wishes to check his or her mail, the Email Recipient may connect to the Email Classifier (22) rather than directly to the server on which the Mailbox (41) resides.

The Email Classifier may then act as a proxy. The Email Classifier may read the email from the Mailbox (41), analyze it using techniques specific to that classifier, and classify it as “spam” or “not spam”. Since proxy email classifiers do not generally send email to multiple email addresses, they may alter the email itself to indicate the results of the classification. According to an embodiment, this may be done by adding an additional email header and/or modifying the subject line of the incoming email. For example, upon classifying an email as “spam,” the email classifier might add the header “Classification: spam” to the processed email.

The email classifier (22) may then save a copy of the original, unmodified email, preferably including header information, in the Email Database (23). The email classifier (22) may then create an index as described in the pervious section. In an alternative embodiment the statistics derived from the analysis may be stored instead of the complete email.

According to an embodiment, the email client software running on the Email Recipient's (26) computer may then sort or otherwise processes the email based on the modifications performed by the proxy email classifier. For example, email containing the header “Classification: spam” might be moved to a special spam folder configured in the email client software. In one embodiment, the settings of the email client may be changed without modifying the email client software.

According to an embodiment of the present invention, after receiving an email from an email classifier such as those shown in FIG. 1 or FIG. 4, the Email Recipient (26) may wish to provide one or more example emails as feedback to the Email Classifier (22) to reinforce the email classifier's classification, or to correct an incorrect classification.

FIG. 5 shows an example of how an email recipient uses dedicated control mailboxes to train an email classifier according to an embodiment of the present invention. In this example, the Email Recipient (26) may provide an example of a spam email for training. A separate control mailbox is created for each category for which feedback is to be provided, and email recipients may forward example emails to the appropriate control mailbox.

In FIG. 5, the Email Recipient (26) is shown to have forwarded the example email to the Spam Control Mailbox (51). In this example, we will refer to the original email received by the Email recipient as the “example email” and the forwarded email sent to the control mailbox as the “training email.” The example email is preferably contained in either the body of the training email or as an attachment to the training email. Examples of different forwarding formats are given in the detailed discussion of the Training Email Retriever (53) and the Email Database (23).

According to this embodiment, the Training Email Retriever (53) may check the control mailboxes (51, 52) periodically. The Training Email Retriever may then extract the header information and/or the content of the example email from the body of the training email. The Training Email Retriever may then use that information to retrieve the original example email, and/or its derived statistics, from the Email Database (23). The details of the email extraction and retrieval are explained in detail below.

The Training Email Retriever (53) may then use the information retrieved from the email database and/or the category corresponding to the control mailbox to instruct the Email Classifier (22) to update a filter. The specific details of this communication depend on the nature of the Email Classifier used in the embodiment. The communication will preferably rely on either integration of the Training Email Retriever and the Email Classifier or the Application-Program Interface (API) of the Email Classifier.

It is noted that if the example email of the embodiment shown in FIG. 5 was a “No Spam” email, the Email Recipient 26 would forward the email to the NoSpam Control Mailbox 52. The email would then be treated in a similar fashion as described above regarding the Spam email.

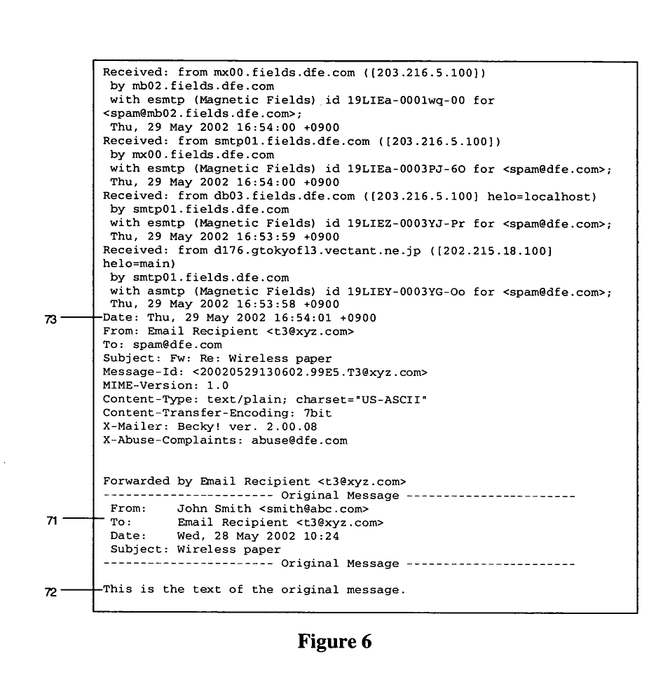

FIG. 6 shows an example of a training email generated using a typical email client according to an embodiment of the present invention. The training email may then be used to forward the example email shown in FIG. 2. In this example, the email client has removed most of the header information from the example email before placing the example email's header information in a header block (71) in the body of the training email. The body of the example email (72) typically follows the header block.

The Training Email Retriever may then extract the header information from the header block (71) and use it to retrieve the original email or its derived statistics from the Email Database. However, since the information contained in the header block and its format can vary greatly among email clients, various embodiments employ a novel technique, hereinafter referred to as “Adaptive Header Resolution”, to extract the header information and retrieve the data from the email database.

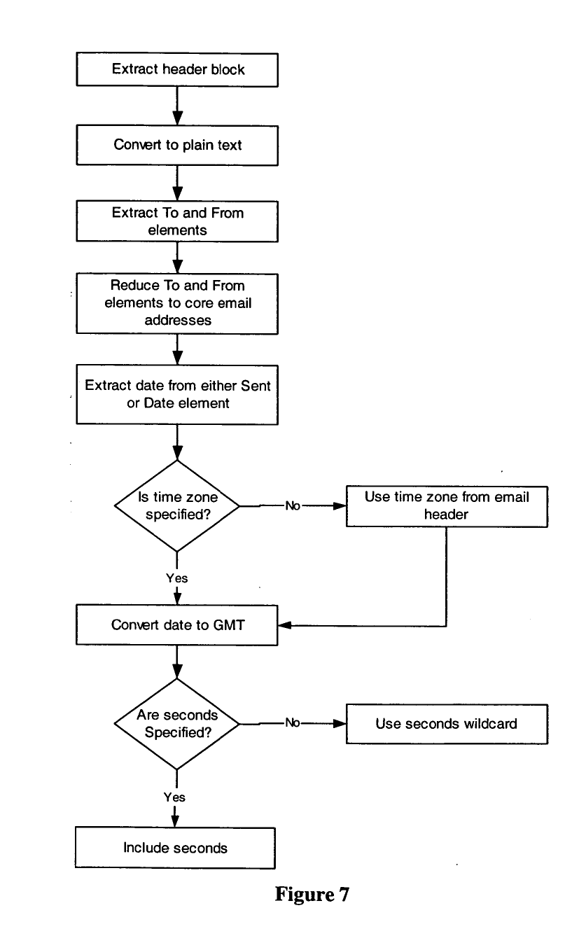

FIG. 7 shows an example of how Adaptive Header Resolution may extract the index information from the header block according to an embodiment of the present invention. If the header block of the training email is in html format, it may be converted into plain text. The To and From email elements may then be extracted and stripped of all text that is not part of the basic email address. In the example shown in FIG. 6, the To element would be extracted as “t3 @xyz.com” and the From element would be extracted as “smith@abc.com.”

In this embodiment of the present invention the email may be extracted from the plain text header information rather than the HTML header information. The email addresses are then preferably reduced to their most basic form to compensate for the formats that may be used by different email clients when creating a header block of a forwarded email. For example, some email clients include extra address information such as the individual's name, some include extra information in an altered form, some hide the basic email address inside html formatting, and some forward just the basic email address.

Most email clients create a Date or Sent element in the header block, but there is no reliable standard. Various embodiments compensate for this by extracting the date and/or time information from either the Sent or the Date element depending on which is present. Likewise, the format and meaning of the Date and Sent elements vary depending on the email client used to generate the training email. Some email clients convert this date element to the time zone of the computer in which they are installed unless the time zone is explicitly specified in the date element. In an embodiment of the present invention, the time zone specified in the Date header of the training email (73) may be assigned. This date and time information may then be normalized, for example, converted to GMT, in a similar manner to that by which the date and time information is normalized when the index to the email database is created. If the extracted date and time information contains seconds, those seconds are preferably recorded. If not, a wildcard is preferably used.

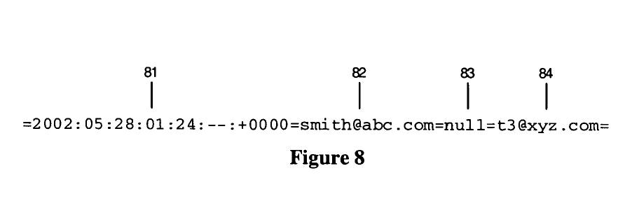

FIG. 8 shows an example of a search index generated from the training email shown in FIG. 6 using the same format as the sample index entry shown in FIG. 3. This search index may be suitable for searching a text-base email database, and is an example of but one embodiment of the invention. It will be readily apparent to those skilled in the art that the present invention is not restricted to this specific embodiment but applies to the many index formats that could be used in this situation. Likewise, the present invention also applies to embodiments where the search takes place algorithmically and does not generate a search index.

An example of such an algorithmic search is a progressive search in which all records matching a given “date” field are retrieved, and then all the records in that set matching a given “from” field are retrieved, with the process continuing until all the desired criteria are applied. The criteria used and the order shown in the example are used to show the concept only, and are not intended to limit in any way the algorithmic searches that may be used with the present invention.

The date field (81) uses the dash character as a wildcard since seconds information was missing in the date element in the header block of the training email. The From field (82) and the To field (84) may not be present in various embodiments. The index field that corresponds to the Sender information (83) is absent here since no corresponding element was extracted from the header block in this example. However, it is shown here for clarification.

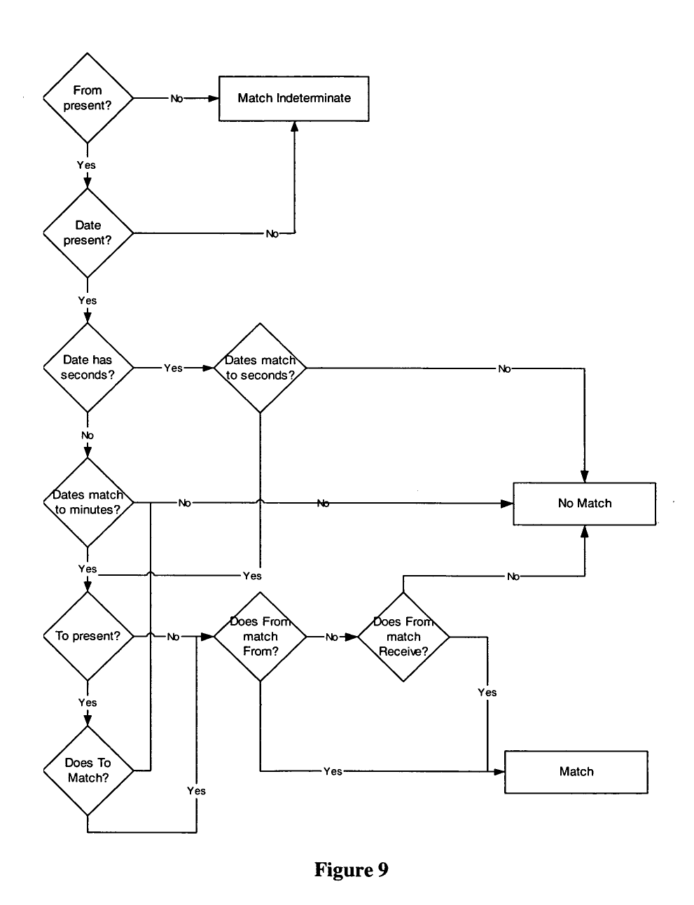

FIG. 9 illustrates an example of a method according to an embodiment of the present invention in which data is retrieved from the email database once the search index has been constructed. In this example, both the Date filed (81) and the From field (82) must be present for the retrieval to take place. If the Date field in the search index contains seconds, it must match the database index Date field (31) to the second. If the Date field of the search index does not contain second information, it must match the database index Date entry to the minute. If the To field (84) is present in the search index it must match the database index entry's To element (34) exactly (with upper and lower case letters preferably being considered the same). In an alternate embodiment, the matching described above is case sensitive, however, internet addressing is generally not case sensitive, and therefore case sensitive matching is generally not used.

In this embodiment, the From field (82) in the search index is considered to match if it matches either the database index From field (32) or the database index Sender field (33). This embodiment of present invention may perform this multiple comparison on the From and Sender index fields to compensate for the non-standard behavior of email clients. Some email clients, such as Microsoft Outlook, will substitute the Sender header for the From header in the header block (71) when creating a forwarded email, if the Sender header is present in the example email. Other email clients do not make this substitution or do it under different circumstances.

In an alternative embodiment, where the full text of the original email is stored in the email database, the text contained in the body of the training email (72) may be used to retrieve the original email from the database when the From field (82) and/or the Date field (81) is missing from the search index. A preferred embodiment stores only derived statistics from the original email and indexes the statistics using the To, From, Date, and/or Sender information as described above. In this way, the email database is far more secure since it does not store potentially sensitive information such as the subject and contents of the email it processes.

In an alternative embodiment, the example emails may be sent as attachments to the training emails with the header information included. The most common format for such attachments is defined in Internet RFC-1521 “MIME (Multipurpose Internet Mail Extensions) Part One: Mechanisms for Specifying and Describing the Format of Internet Message Bodies.” Most popular email clients implement this format. When emails are forwarded as attachments, the email database is optional. However, by retrieving the derived statistics from the email database, various embodiments of the present invention may confirm that the example email was in fact sent to the person sending training email. The system is thereby made more secure and less susceptible to malicious and incorrect training of email classifiers (22).

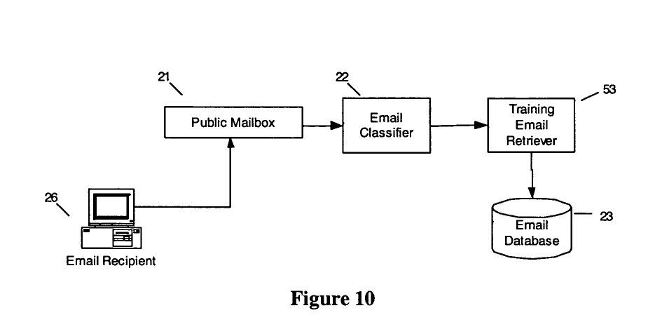

FIG. 10 illustrates an example of an embodiment that uses a general control mailbox. As in the discussion of the dedicated control mailbox, the Email Recipient (26) wishes to train the Email Classifier (22) using one or more example emails. In one embodiment, the Email Recipient may forward the example email to a public mailbox (21) in the case of a routing email classifier. If a general control mailbox is used with the proxy email classifier shown in FIG. 4, the Email recipient (26) may forward the example email to the mailbox (41) instead of sending the example email to the email classifier (22) as shown in FIG. 4.

The email classifier (22) may distinguish the training email from regular email by detecting a text-based instruction at a pre-defined location in the training email. Although this instruction can be placed at any position in the body or header of the training email, in a preferred embodiment, this instruction takes the form of the text “category:”, followed by the name of the category for which the email classifier uses the example emails to train. Email having a body beginning in any other way may be processed and routed as regular email according to the rules of the email classifier.

For example, the email classifier (22) treats email where a first line of the body is “category: spam” as a training email for the spam category. The training email retriever (53) may then retrieve the derived statistics from the email database (23) and update the email classifier as explained previously.

The use of a this text-based instruction enables email recipients to provide feedback to the email classifier without the use of a dedicated interface, although a dedicated interface can be used to create and/or send the training email.

Some parties, for example the senders of unsolicited email, would likely seek to corrupt the email classifier (22) by sending their own training emails to the public mailbox (21). According to an embodiment, this may be prevented by including a password on the second line of the training email in the form “password:”, followed by the actual password. If the password is incorrect, the email classifier may discard the training mail.

While the embodiments described above have been illustrated using email, alternate embodiments of the present invention apply similarly to non-email electronic communications.

In view of the many possible embodiments of the present invention, it should be recognized that the detailed embodiments are illustrative only and should not be taken as limiting the scope of the invention. Rather, we claim as the invention all such embodiments as may come within the scope and spirit of the following claims and equivalents thereto.

1. A method comprising:
providing feedback to a classifier
creating a database using a first electronic communication processed by the classifier,
forwarding a second electronic communication based on the first electronic communication to a specified mailbox to be used as a feedback example,
extracting header information from the second electronic communication,
using the extracted header information to retrieve the first electronic communication from the database, and
training the classifier using the first electronic communication as an example of a category indicated by the specified mailbox at which the second electronic communication was received.

2. The method of claim 1, in which the creating of a database comprises deriving statistics from the first electronic communication and storing the derived statistics in the database.

3. The method of claim 1, further comprising attaching the first electronic communication to the second electronic communication.

4. The method of claim 3, in which the attached first electronic communication is re-analyzed by the classifier.

5. The method of claim 1, further comprising indicating the category with a text command that appears at a predefined location in the second electronic communication.

6. The method of claim 1, further comprising creating the second electronic communication using a dedicated user interface.

7. The method of claim 3, further comprising creating the second electronic communication using a dedicated user interface.

8. The method of claim 5, in which the predefined location is in a body of the second electronic communication.

9. The method of claim 5, further comprising sending the second electronic communication to the same mailbox that is checked by the classifier, and only an electronic communication having said command is processed as a second electronic communication.

10. The method of claim 5, further comprising indicating the category by providing the word “category” or one of its synonyms on a first line of the second electronic communication.

11. The method of claim 10, further comprising indicating the category by providing information in a subject line of the second electronic communication.

12. The method of claim 10, further comprising indicating the category by providing information in the header information of the second electronic communication.

13. The method of claim 5, further comprising providing additional security by providing a password in a body of the second electronic communication.

14. The method of claim 1, in which the first electronic communication and the second electronic communication are email.

15. A method for storing and retrieving an electronic communication or information derived from the electronic communication, the method comprising:
storing information derived from an electronic communication by,
creating an index based on header information of the electronic communication,
removing non-essential and descriptive information from the header information,
storing the remaining information such that it is linked to said index, and
retrieving the stored information by,
forwarding the electronic communication to a designated mailbox,
extracting the original electronic communication's header information from a header block of the forwarded electronic communication, and
retrieving the information based on this these extracted headers.

16. The method of claim 15, further comprising storing a complete copy of the electronic communication.

17. The method of claim 15, further comprising storing statistical information derived from the original electronic communication.

18. The method of claim 15, further comprising sending information derived from the original electronic communication as an attachment to the forwarded electronic communication, and extracting the header information from the header of the attached electronic communication rather than the header block of the forwarded electronic communication.

19. The method of claim 15, further comprising converting a Date header stored in the index and a date information extracted from the header block of the forwarded electronic communication to a common time zone.

20. The method of claim 15, further comprising extracting either a Sent or a Date information from the header block and matching the extracted information to respective indexed Sent or Date fields in the header.

21. The method of claim 15, in which a date and time of the forwarded electronic communication will be considered a match to an indexed Date field if the forwarded electronic communication contains seconds information and it matches to the second, the date and time of the forwarded electronic communication will be considered a match to the index Date field if the forwarded electronic communication does not contain seconds and it matches to the minute.

22. The method of claim 15, further comprising setting the extracted date's time zone to a time zone of the training electronic communication if the time zone information is missing.

23. The method of claim 15, further comprising storing the non-essential information in the index and using the non-essential information to retrieve the stored information.

24. The method of claim 15, in which an extracted From field is considered to match an index entry if it matches a From or Sender field of the electronic communication.

25. The method of claim 15, wherein if either a To or a From header cannot be extracted from the header block, then the field that is extracted is used in conjunction with a Date field to match the index.

26. The method of claim 15, wherein the header information of the electronic communication comprises Date, To, From, and Sender information.

27. A system to provide feedback to an classifier, the system comprising:
a classifier to classify received electronic communications,
a database to store received electronic communication information, and
a plurality of user mailboxes to allow users to access electronic communications,
wherein
the classifier receives a first electronic communication,
the classifier stores information relating to the first electronic communication in the database,
the classifier constructs an index of the stored information based on a header of the first electronic communication,
the classifier forwards the first electronic communication to one of the plurality of user mailboxes,
a user determines if the first electronic communication is to be used to train the classifier,
if the first electronic communication is to be used to train the classifier, the user provides a second electronic communication containing information about the first electronic communication to the classifier, and
the classifier updates one of a plurality of classification filters based on the second electronic communication.

28. The system according to claim 27 wherein the electronic communications are email.

29. The system according to claim 27 wherein the information relating to the first electronic communication that is stored in the database comprises the complete text of the first electronic communication.

30. The system according to claim 27 wherein the information relating to the first electronic communication that is stored in the database comprises statistical information derived from the first electronic communication.

31. The system according to claim 27 wherein the information relating to the first electronic communication that is stored in the database comprises the body of the first electronic communication.

32. The system according to claim 27 wherein the information relating to the first electronic communication that is stored in the database comprises header information.

33. The system according to claim 27 further comprising providing the second electronic communication to the classifier by sending the second electronic communication to a general control mailbox.

34. The system according to claim 27 further comprising providing the second electronic communication to the classifier by sending the training electronic communication to a specific control mailbox.

35. The system according to claim 27 further comprising attaching a copy of the first electronic communication to the second electronic communication.

36. The system according to claim 27, wherein the classifier retrieves the first electronic communication in response to the second electronic communication.

37. The system according to claim 27 wherein the classifier analyses the first electronic communication in response to the second electronic communication.

38. The system according to claim 33 further comprising determining which of the plurality of classification filters is to be updated according to a text command located at a predetermined location in the second electronic communication.

39. The system according to claim 38 wherein the general control mailbox processes electronic communications containing the text command as second electronic communications, and processes electronic communications not containing the text command as first electronic communications.

40. The system according to claim 38 wherein the text command is located in the body of the second electronic communication.

41. The system according to claim 38 wherein the text command includes the word category, and is located on the first line of the second electronic communication.

42. The system according to claim 38 wherein the text command is located in a subject line of the second electronic communication.

43. The system according to claim 38 wherein the text command is located in the header of the second electronic communication.

44. The system according to claim 34 further comprising updating the one of the plurality of classification filters according to the specific control mailbox to which the second electronic communication is sent.

45. The system according to claim 27 wherein the second electronic communication is generated by a dedicated user interface.

46. The system according to claim 27 wherein the classifier updates one of a plurality of classification filters only if the second electronic communication is an authorized second electronic communication.

47. The system according to claim 46 wherein authorized second electronic communications are authenticated using a password.

48. A method for training a classifier comprising:
receiving a first electronic communication,
storing information associated with the first electronic communication,
forwarding the first electronic communication to a user,
receiving a second electronic communication from a user, and
updating one of a plurality of classification filters based on the second electronic communication.

49. The method of claim 48 wherein the information regarding the first electronic communication is stored in a database.

50. The method of claim 48 wherein the stored information is a body of the first electronic communication.

51. The method of claim 49, wherein the stored information is statistical information derived from the first electronic communication.

52. The method of claim 48, further comprising attaching the first electronic communication to the second electronic communication.

53. The method of claim 49, further comprising including header information from the first electronic communication in the second electronic communication.

54. The method of claim 53, further comprising retrieving the stored information from the database based on the header information included in the second electronic communication.

55. The method of claim 54, wherein the updating one of a plurality of classification filters based on the second electronic communication is performed using the retrieved information.

56. The method of claim 49, further comprising creating an index of the information stored in the data base.

57. The method of claim 56, wherein the index is created using header information.

58. The method of claim 48, wherein the updating one of a plurality of classification filters based on the second electronic communication comprises:
reducing the header information of the first electronic communication into a generic format regardless of which of a plurality of electronic communication clients has been used, and using the reduce header information to update the classification filter.

59. The method of claim 48, wherein the second electronic communication and the first electronic communication are both received by a general mailbox.

60. The method of claim 48, wherein the second electronic communication is received by a specific mailbox related to a particular one of the plurality of classification filters.

61. The method of claim 48, wherein the electronic communications are emails.

62. A method of training an electronic communication classifier comprising:
receiving a first electronic communication, the first electronic communication comprising a plurality of example communications,
extracting the plurality of example communications from the first electronic communication, and
modifying one of a plurality of classification filters based on the extracted example communications.

63. The method of claim 62, wherein the first electronic communication and the example communications are email.

64. The method of claim 62, wherein the first electronic communication is received by a general control mailbox.

65. The method of claim 62, wherein the first electronic communication is received by a specific control mailbox.

66. The system according to claim 62, wherein the classifier updates the one of a plurality of classification filters only if the first electronic communication is authorized.

67. The system according to claim 62, further comprising authorizing second electronic communications using a password.
